(19) United States
(12) Patent Application Publication
(10) Pub. No.: US 2023/0153607 A1
(43) Pub. Date: May 18, 2023

(54) METHOD AND SYSTEM FOR ATTENTIVE ONE SHOT META IMITATION LEARNING FROM VISUAL DEMONSTRATION

(71) Applicant: Tata Consultancy Services Limited, Mumbai (IN)

(72) Inventors: Vishal Kumar BHUTANI, Bangalore (IN); Anima Majumder DUTTA, Bangalore (IN); Rajesh SINHA, Noida (IN); Samrat DUTTA, Bangalore (IN)

(73) Assignee: Tata Consultancy Services Limited, Mumbai (IN)

(21) Appl. No.: 17/970,886

(22) Filed: Oct. 21, 2022

(30) Foreign Application Priority Data
Nov. 17, 2021 (IN) 202121052813

(51) Int. Cl. G06N 3/08

(52) U.S. Cl. CPC G06N 3/08

(57) ABSTRACT

The present disclosure provides an adaptive meta-learning technique for determining robotic action. Conventional methods are focusing on task-relevant aspects of the input observations and fails to provide adaptive learning. Initially, a plurality of images pertaining to a visual demonstration for a robot are received by the system. Further, a plurality of vector embeddings are computed based on the plurality of images using an attentive embedding network. The attentive embedding network includes a first Convolutional Neural Network (CNN), a fully connected layer and a plurality of spatial attention modules. Finally, a control action is computed based on the plurality of vector embeddings, an image from the plurality of images, a robot joint state vector and robot joint velocity vector using a control network. The control network comprises a second CNN and a plurality of fully connected layers. The control network is connected to the attentive embedding using multiplicative spatial skip connections.

### PRIORITY CLAIM

This U.S. patent application claims priority under 35 U.S.C. § 119 to: Indian Patent Application No. 202121052813, filed on Nov. 17, 2021. The entire contents of the aforementioned application are incorporated herein by reference.

### TECHNICAL FIELD

The disclosure herein generally relates to the field of machine learning and, more particular, to a method and system for attentive one shot meta imitation learning from visual demonstration.

### BACKGROUND

Imitation learning (IL) aims at enabling robots to learn skills from a human or a robot teacher efficiently by avoiding rigorous task specific robot programming which lacks adaptability, Due to the recent success of deep learning in the field of computer vision, there is a growing trend in the current IL research to learn control policy directly from video demonstrations which is otherwise known as visual imitation learning. The Meta-Imitation Learning (MIL) is a significant method in this field that allows a policy learned during training to be adapted quickly to solve a new task during the testing phase given one or more demonstrations. It, however, has the limitation of losing its meta-learning ability after learning a specific task.

Conventional methods improve the performance of various machine learning models by focusing on task-relevant aspects of the input observations. This, in turn, provides increased learning efficiency and robustness to distractors (e.g., background clutter). These have been successfully used to solve a wide range of problems such as language modeling, machine translation, image captioning and the like. However, application of attention to visual imitation has been very limited. Few conventional visual imitation methods utilize a transformer-based attention model to extract features from input images which are then used for learning the policy function. Hence, there is a challenge in investigating the effect of attention on the meta-learning models for visual imitation.

### SUMMARY

Embodiments of the present disclosure present technological improvements as solutions to one or more of the above-mentioned technical problems recognized by the inventors in conventional systems. For example, in one embodiment, a method for attentive one shot meta imitation learning from visual demonstration is provided. The method includes receiving, by one or more hardware processors, a plurality of images pertaining to a visual demonstration for a robot, wherein the plurality of images are sequential. The method further includes computing, by the one or more hardware processors, a plurality of vector embeddings based on the plurality of images using a pretrained attentive embedding network. he pretrained attentive embedding network comprises a first Convolutional Neural Network (CNN), a fully connected layer and a plurality of spatial attention modules, and wherein computing the plurality of vector embeddings comprises; (i) computing a plurality of local contextual feature vectors based on the plurality of images by the first CNN (ii) computing a plurality of attention vectors based on the plurality of local contextual feature vectors and a current global feature vector using a corresponding spatial attention module among the plurality of spatial attention modules (iii) computing a plurality of elementwise dot products comprising an elementwise dot product between each of the plurality of attention vectors and each a corresponding plurality of local contextual feature vector (iv) generating a new global vector by concatenating the plurality of elementwise dot products and (v) computing the plurality of vector embeddings based on the new global vector using the fully connected layer of the attentive embedding network. The method finally includes computing, by the one or more hardware processors, a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

In another aspect, a system for attentive one shot meta imitation learning from visual demonstration is provided. The system includes at least one memory storing programmed instructions, one or more Input/Output (I/O) interfaces, and one or more hardware processors operatively coupled to the at least one memory, wherein the one or more hardware processors are configured by the programmed instructions to receive a plurality of images pertaining to a visual demonstration for a robot, wherein the plurality of images are sequential. The one or more hardware processors are configured by the programmed instructions to compute a plurality of vector embeddings based on the plurality of images using a pretrained attentive embedding network. he pretrained attentive embedding network comprises a first Convolutional Neural Network (CNN), a fully connected layer and a plurality of spatial attention modules, and wherein computing the plurality of vector embeddings comprises; (i) computing a plurality of local contextual feature vectors based on the plurality of images by the first CNN (ii) computing a plurality of attention vectors based on the plurality of local contextual feature vectors and a current global feature vector using a corresponding spatial attention module among the plurality of spatial attention modules (iii) computing a plurality of elementwise dot products comprising an elementwise dot product between each of the plurality of attention vectors and each a corresponding plurality of local contextual feature vector (iv) generating a new global vector by concatenating the plurality of elementwise dot products and (v) computing the plurality of vector embeddings based on the new global vector using the fully connected layer of the attentive embedding network. Finally, the one or more hardware processors are configured by the programmed instructions to compute a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

In yet another aspect, a computer program product including a non-transitory computer-readable medium having embodied therein a computer program for attentive one shot meta imitation learning from visual demonstration is provided. The computer readable program, when executed on a computing device, causes the computing device to receive a plurality of images pertaining to a visual demonstration for a robot, wherein the plurality of images are sequential. The computer readable program, when executed on a computing device, causes the computing device to compute a plurality of vector embeddings based on the plurality of images using a pretrained attentive embedding network. he pretrained attentive embedding network comprises a first Convolutional Neural Network (CNN), a fully connected layer and a plurality of spatial attention modules, and wherein computing the plurality of vector embeddings comprises; (i) computing a plurality of local contextual feature vectors based on the plurality of images by the first CNN (ii) computing a plurality of attention vectors based on the plurality of local contextual feature vectors and a current global feature vector using a corresponding spatial attention module among the plurality of spatial attention modules (iii) computing a plurality of elementwise dot products comprising an elementwise dot product between each of the plurality of attention vectors and each a corresponding plurality of local contextual feature vector (iv) generating a new global vector by concatenating the plurality of elementwise dot products and (v) computing the plurality of vector embeddings based on the new global vector using the fully connected layer of the attentive embedding network. Finally, computer readable program, when executed on a computing device, causes the computing device to compute a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for attentive one shot meta imitation learning from visual demonstration, in accordance with some embodiments of the present disclosure.

FIG. 2 is an exemplary flow diagram illustrating a method for attentive one shot meta imitation learning from visual demonstration, implemented by the system of FIG. 1, in accordance with some embodiments of the present disclosure.

FIG. 3A is an example overall architecture for the processor implemented method for attentive one shot meta imitation learning from visual demonstration implemented by the system of FIG. 1, in accordance with some embodiments of the present disclosure.

FIG. 3B is an example architecture for an attentive embedding network for the processor implemented method for attentive one shot meta imitation learning from visual demonstration implemented by the system of FIG. 1, in accordance with some embodiments of the present disclosure.

FIG. 3C is an example architecture for a control network for the processor implemented method for attentive one shot meta imitation learning from visual demonstration implemented by the system of FIG. 1, in accordance with some embodiments of the present disclosure.

FIG. 3D is an example architecture for an attention module for the processor implemented method for attentive one shot meta imitation learning from visual demonstration implemented by the system of FIG. 1, in accordance with some embodiments of the present disclosure.

FIGS. 4A to 4D illustrates experimental details for the processor implemented method for attentive one shot nets imitation learning from visual demonstration implemented by the system of FIG. 1, in accordance with some embodiments of the present disclosure.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments.

Embodiments herein provide a method and system for attentive one shot meta imitation learning from visual demonstration for applying a previously learned skill to a new task context by a robot. Initially, a plurality of images pertaining to a visual demonstration for a robot are received by the system. The plurality of images are sequential. Further, a plurality of vector embeddings are computed based on the plurality of images using a pretrained attentive embedding network. The pretrained attentive embedding network includes a first Convolutional Neural Network (CNN), a fully connected layer and a plurality of spatial attention modules. Finally, a control action is computed based on the plurality of vector embeddings, an image from the plurality of images, a robot joint state vector and robot joint velocity vector using a control network. The control network comprises a second CNN and a plurality of fully connected layers. The control network is connected to the attentive embedding using multiplicative spatial skip connections.

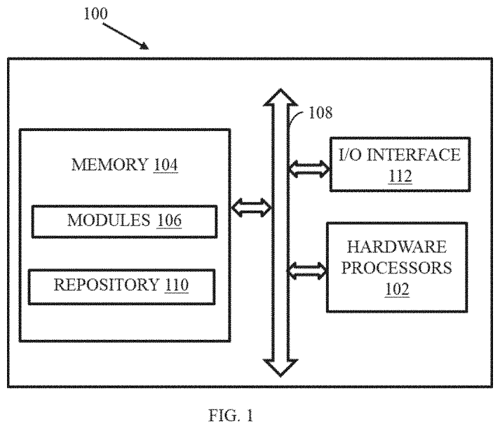

Referring now to the drawings, and more particularly to FIGS. 1 through 4D, where similar reference characters denote corresponding features consistently throughout the figures, there are shown preferred embodiments and these embodiments are described in the context of the following exemplary system and/or method.

FIG. 1 is a functional block diagram of a system 100 for attentive one shot meta imitation learning from visual demonstration, according to some embodiments of the present disclosure. The system 100 includes or is otherwise in communication with hardware processors 102, at least one memory such as a memory 104, an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

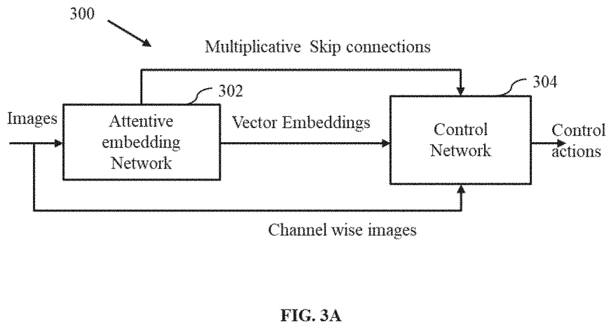

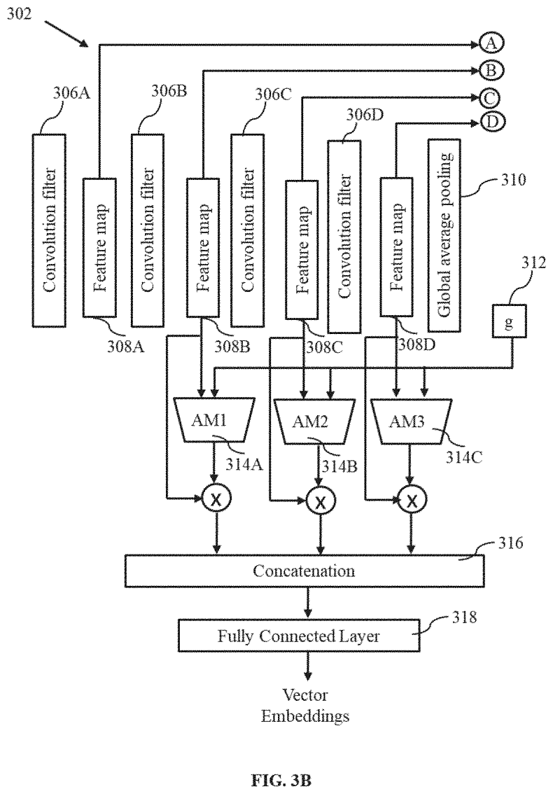

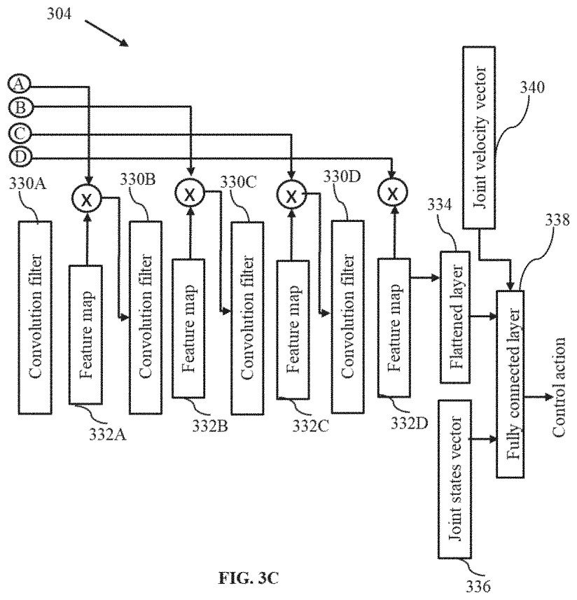

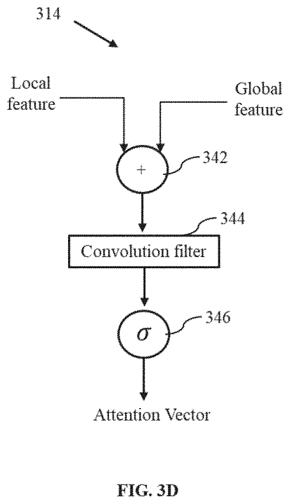

The plurality of modules 106 include programs or coded instructions that supplement applications or functions performed by the system 100 for attentive one shot meta imitation learning from visual demonstration. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for attentive one shot meta imitation learning from visual demonstration. In an embodiment, plurality of modules 106 includes an attentive embedding network (shown in FIG. 3B) and a control network (shown in FIG. 3C).

The data repository (or repository) 110 may include a plurality of abstracted piece of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (repository 110) communicatively coupled to the system 100. The data contained within such external database may be periodically updated. For example, new data may be added into the database (not shown in FIG. 1) and/or existing data may be modified and/or non-useful data may be deleted from the database. In one example, the data may be stored in an external system, such as a Lightweight Directory Access Protocol (LDAP) directory and a Relational Database Management System (RDBMS).

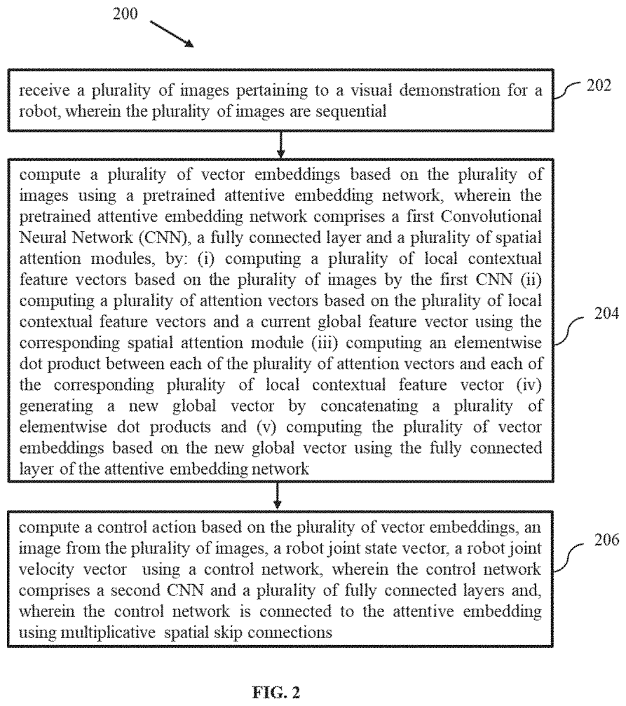

FIG. 2 is an exemplary flow diagram illustrating a method 200 for attentive one shot meta imitation learning from visual demonstration implemented by the system of FIG. 1 according to some embodiments of the present disclosure. In an embodiment, the system 100 includes one or more data storage devices or the memory 104 operatively coupled to the one or ore hardware processor(s) 102 and is configured to store instructions for execution of steps of the method 200 by the one or more hardware processors 102. The steps of the method 200 of the present disclosure will now be explained with reference to the components or blocks of the system 100 as depicted in FIG. 1 and the steps of flow diagram as depicted in FIG. 2. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communication network. The order in which the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

At step 202 of the method 200, the one or more hardware processors 102 are configured by the programmed instructions to receive a plurality of images pertaining to a visual demonstration for a robot. The plurality of images are sequential demonstrating a corresponding action at each time stamp. For example, a plurality of image frames from a video demonstration are received as input.

At step 204 of the method 200, the one or more hardware processors 102 are configured by the programmed instructions to compute a plurality of vector embeddings based on the plurality of images using a pretrained attentive embedding network. The pretrained attentive embedding network includes a first Convolutional Neural Network (CNN), a fully connected layer and a plurality of spatial attention modules. The plurality of vector embeddings are computed by the pretrained attentive embedding network as follows. Initially, a plurality of local contextual feature vectors are computed based on the plurality of images by the first CNN. Further, a plurality of attention vectors are computed based on the corresponding plurality of local contextual feature vectors and a current global vector using a corresponding spatial attention module among the plurality of spatial attention modules. Further, a plurality of elementwise dot products comprising an elementwise dot product is computed between the plurality of local contextual feature vectors and each of a corresponding plurality of attention vectors. Further, a new global vector is generated by concatenating the plurality of elementwise dot products. Finally, the plurality of vector embeddings are computed based on the new global vector using the fully connected layer of the attentive embedding network.

In an embodiment, each of the plurality of spatial attention modules includes an addition unit, a convolution unit and a sigmoid activation function. The global vector is obtained from the final layer of the first CNN, The spatial attention module is illustrated in FIG. 3C.

In an embodiment, the method of training the attentive embedding network is explained below: In an embodiment, the dataset D is divided into subset of datasets D₁, D₂, . . . Dₖ where, each subset of datasets {D} has a support set D_{U} and a query set D_{Q}. The support set D_{U} includes a different category of tasks {T_{U}ⁱ, T_{U}^{j}} and the query set D_{Q} includes a set of tasks {T_{Q′}^{j}} belonging to one of the categories from the support set. Each task has M number of demonstrations. A first plurality of vector embeddings corresponding to each of the plurality of tasks associated with the support dataset are computed using the attentive embedding network f_{θ}:R^{D}→R^{N} which estimates an N-dimensional embedding vector εₖ^{j}∈R^{N} for a given demonstration Tₖ where Tₖ∈T^{j}. The normalized mean embeddings ε^{j}∈R^{N} is calculated using all M demonstrations of the task T^{j}. The first plurality of vector embeddings associated with the support dataset are normalized using a normalization technique. The normalized mean embeddings ε^{j}∈R^{N} is calculated using all M demonstrations of the task T^{j} as shown in equation (1).

$${ε}^{j} = {[ \frac{1}{M} {\sum }_{{T}_{k}^{j} = {T}^{j}} {f}_{θ} ( {T}_{k}^{j} ) ]}^{\hat{}} \qquad ( 1 )$$

where

$${U}^{\hat{}} = \frac{v}{‖ v ‖}$$

Further, a second plurality of vector embeddings corresponding to each of the plurality of tasks associated with the query dataset are computed using the attentive embedding network. Further, the dot product similarity is computed between the first plurality of normalized vector embeddings and the second plurality of vector embeddings. Further, the attentive embedding network is trained based on the computed dot product similarity. The training is continued until the dot product similarity between the first plurality of normalized vector embeddings and the second plurality of vector embeddings are greater than a predefined similarity threshold.

The embedding loss L_{emb} used to train the attentive embedding network is given in equation 2.

L_{emb}=Σ_{T}_{ₖ}_{^{j}}_{=T}_{^{j}}Σ_{T}_{ⁱ}_{=T}_{^{j}} max[0,margin−ε_{k,Q}^{j}·ε_{U}^{j}+ε_{k,Q}^{j}·ε_{U}^{j}] (2)

where ε_{k,Q}^{j} is an embedding vector for k^{th} demonstration of the task {T_{Q}^{j}} for the query set and ε_{U}^{j}, ε_{U}^{j} are the normalized embeddings for the task {T_{U}ⁱ,T_{U}^{j}} taken from the support set. The model is trained to produce a higher dot-product similarity between a task's demonstration ε_{K,Q}^{j} and its average embeddings εᵢⱼ^{j} than to from other tasks each of the sampled tasks chosen at the time of training are unique. AH the other tasks in the support set are considered to be negative Tᵢ. Therefore, each task within a support set, is compared to every other task. The value of margin in L_{emb} is varied from 0.1 to 1.

In an embodiment, the spatial attention module of the attentive embedding network is incorporated to make the embeddings more robust by extracting features from multiple layers of the attentive-embedding network. The local feature vector Lₛ is defined as Lₛ={l₁^{s}, l₂^{s}, . . . lₙ^{s}}, where lᵢ^{s} are the local contextual features extracted from the convolution layer at the i^{th} spatial location. Let g be the global feature vector which is the output of the final convolutional layer. In order to integrate attention in the global feature vector g, the compatibility score is given inequation (3).

c(\hat{L}^{s},g)={l₁^{s},l₂^{s}, . . . lₙ^{s}} (3)

where, (\hat{L}^{s}) is a set of vectors after it is linearly mapped to the dimensionality of g. The compatibility function used here is calculated between Lₛ and g as given in equation (4).

cᵢ^{s}=<u,lᵢ^{s}+g>,i∈{1 . . . n} (4)

where u is the weight vector learned by 1×1 convolutional layer that takes the sum of components as input and gives the compatibility scores as output. The compatibility scores are further passed through the sigmoid activation function to get normalized compatibility scores Aₛ={A₁^{s}, A₂^{s}, . . . Aₙ^{s}}. In an embodiment, the normalized compatibility score can be alternatively represented as attention vector. These normalized compatibility scores are then used to compute the vector gₐ^{s} for each layers by using elementwise dot product (gₐ^{a}=Σᵢ₌₁ⁿaᵢ^{s}·lᵢ^{s}. These vectors are then concatenated. The concatenated feature vector replaces the original vector g to get the attention integrated global vector gₐ={gₐ¹, gₐ², . . . gₐⁿ}. This vector gₐ is further passed through the fully connected layers to get the embedding vector ε.

At step 206 of the method 200, the one or more hardware processors 102 are configured by the programmed instructions to compute a control action based on the plurality of vector embeddings, a robot joint state vector, a robot joint velocity vector and the image from the plurality of images, using a control network. In an embodiment, the control action is a robotic torque. The control network includes a second CNN and a plurality of fully connected layers. The control network is connected to the attentive embedding using multiplicative spatial skip connections. For example, the robot joint state vector and the robot joint velocity vector are N×1 vectors. For example, N can be 20.

In an embodiment, the method of computing the plurality of control actions based on the plurality of vector embeddings, the image selected at random from the plurality of images, the robot joint state vector and the robot joint velocity vector using the pretrained control network is explained as follows: Initially, the plurality of vector embeddings, the image from plurality of images, the robot joint state vector and the robot joint velocity vector are received as input by the control network. Further, tiling of the plurality of vector embeddings are performed corresponding to a size associated with the image. The image is selected randomly from the plurality of images. After tiling, a concatenated data is obtained by concatenating the plurality of tiled vector embeddings and the image. After concatenation, a plurality of element-wise feature maps are computed based on the concatenated data using the second CNN. Further, a plurality of fusion feature maps are computed by multiplying each of the plurality of element-wise feature maps with a corresponding feature maps of the attentive embedding network. After computing fusion maps, a flattened feature map is computed based on the plurality of fusion feature maps using the second CNN. Further, a composite feature vector is generated by concatenating the flattened feature map, the robot joint state vector and the robot joint velocity vector. Finally, the control action are computed based on the composite feature vector by using the plurality of fully connected layers of the control network.

In an embodiment, the method of training the control network is explained as follows: The plurality of vector embeddings, the image from the query dataset, the robot joint state vector and the robot joint velocity vector are received as input. Further, tiling is performed on the plurality of vector embeddings corresponding to the size associated with the image. The image is randomly selected from the query dataset, After tiling, the concatenated data is obtained by concatenating the plurality of tiled vector embeddings and the image. Further, the plurality of feature maps are computed based on the concatenated data using the second CNN. After computing feature maps, the plurality of fusion feature maps are computed by multiplying each of the plurality of element-wise feature maps with the corresponding feature maps of the attentive embedding network. Further, a flattened feature map is computed based on the plurality of fusion feature maps using the second CNN. The composite feature vector is generated by concatenating the flattened feature map, the robot joint state vector and the robot joint velocity vector. Further, a first control action is computed based on the composite feature vector by using Fully connected layers. Similarly, a second control action is computed based on the composite feature vector by using Fully connected layers. Further, a total behavioral cloning loss function is computed based on the first control action and the second control action. Finally, the control network is trained based on the total behavioral cloning loss function. In an embodiment, the first control action and the second control actions are robotic torques.

In an embodiment, the control loss L_{ctr} of the control network is defined as given in equations (5) through (7).

L_{ctr}=L_{ctr}^{U}+L_{ctr}^{Q} (5)

L_{ctr}^{Q}=Σ_{T∈T}_{_{Q}}_{ⁱ}Σ_{(o,a)∈T}∥τ(o,ε_{U}^{j})−a∥₂² (6)

L_{ctr}^{U}=Σ_{T∈T}_{_{U}}_{ⁱ}Σ_{(o,a)∈T}∥τ(o,ε_{U}^{j})−a∥₂² (7)

Let L_{ctr}^{Q} and L_{ctr}^{U} are the control loss for the demonstration from query and support set respectively. The control loss L_{ctr} also helps to learn the embeddings. Total loss L_{Total} which is used to train the attentive-embedding network and control network is jointly defined as given in equation (8):

L_{Total}=Σ_{τ}λ_{emb}L_{emb}+λ_{ctr}^{U}L_{ctr}^{U}+λ_{ctr}^{Q}L_{ctr}^{Q} (8)

where, λ_{emb}, λ_{ctr}^{Q} and λ_{ctr}^{U} are the hyperparameters. The input to the attentive embedding network is of dimension, (width, height, 3*|T|). where 3 is for RGB channels. Given a demonstration T we consider only the first and last frame for computing the embeddings. Therefore, input dimension to the attentive-embedding network is (width, height, 6). The embeddings are then tiled and concatenated with the current observation resulting into an input image for the control network of size (width, height, 3+N), where N is the size of embedding vector.

FIG. 3A is an example overall architecture for the processor implemented method for attentive one shot meta imitation learning from visual demonstration implemented by the system of FIG. 1, in accordance with some embodiments of the present disclosure. Now referring to FIG. 3A, the overall architecture includes an attentive embedding network 302 and a control network 304. The attentive embedding network 302 receives the plurality of images and computes the plurality of vector embeddings. The plurality of vector embeddings and the channel wise single image from the plurality of images are provided as input to the control network 304 which in turn computes the control action for the robot. The attentive embedding network 302 and the control network 304 are connected by a plurality of spatial skip connections.

The attentive embedding network 302 is further explained with FIG. 3B. FIG. 3B is an example architecture for attentive embedding network for the processor implemented method for attentive one shot meta imitation learning from visual demonstration implemented by the system of FIG. 1, in accordance with some embodiments of the present disclosure. Now referring to FIG. 3B, the attentive embedding network 302 includes a plurality of convolutional filters 306A to 306D, a plurality of feature maps 308A to 308D, a global average pooling 310, a plurality of spatial attention modules 314A to 314C, a concatenation module 316 and a fully connected layer 318. The connection lines A, B, C and D are the spatial skip connections to the control network 304. A plurality of local contextual feature vectors are computed by the first CNN comprising the plurality of convolutional filters 306A to 306D and the plurality of feature maps 308A to 308D based on the plurality of input images. Further, the plurality of attention vectors are computed based on the plurality of local contextual feature vectors and the current global feature vector using the corresponding plurality of spatial attention modules 314A to 314C. Further, an elementwise dot product between each of the plurality of attention vectors and each of the corresponding plurality of local contextual feature vector are computed by the multiplies associated with the attentive embedding network. Further, the new global vector is computed by concatenating the plurality of elementwise dot products by the concatenation module 316. Finally, the plurality of vector embeddings are computed based on the new global vector using the fully connected layer 318 of the attentive embedding network.

FIG. 3C is an example architecture for control network for the processor implemented method for attentive one shot meta imitation learning from visual demonstration implemented by the system of FIG. 1, in accordance with some embodiments of the present disclosure. Now referring to FIG. 3D, the control network 304 includes the second CNN, a plurality of joint states 336 and a fully connected layer 338. The second CNN includes a plurality of convolution filters 330A to 330D, a plurality of feature maps 312A to 312D, a flattened layer 334. Initially, the plurality of vector embeddings, the image from the plurality of images, the robot joint state vector 336 and the robot joint velocity vector 340 are received by the control network 304. Further, tiling is performed on the plurality of vector embeddings corresponding to the size of the image by the second CNN. Further, a concatenated data is obtained by concatenating the plurality of tiled vector embeddings and the corresponding channel-wise single image by the second CNN. Further, a plurality of element-wise feature maps based on the concatenated data is computed using the second CNN. Further, a plurality of fusion feature maps computed by multiplying each of the plurality of element-wise feature maps with a corresponding feature maps of the attentive embedding network. Further, a flattened feature map is computed based on the plurality of fusion feature maps using the second CNN. A composite feature vector is obtained by concatenating the flattened feature map, the robot joint state vector and the plurality of robot joint state velocity vector. Finally, the control action based on the composite feature vector is computed by using the plurality of fully connected layers 338 of the control network. 304.

The spatial attention modules are explained further with reference to FIG. 3D. An example architecture for attention module for the processor implemented method for attentive one shot meta imitation learning from visual demonstration implemented by the system of FIG. 1 is depicted in FIG. 3D, in accordance with some embodiments of the present disclosure. Now referring to FIG. 3D, the spatial attention module 314 includes an adder 342, a convolution filter 344 and a sigmoid function 346. The local feature and the global feature are given as input to the adder 322 which computes a sum of the local and the global feature. the computed sum is given as input to the convolution filter 324 which computes a compatibility score. The compatibility score is given as input to the sigmoid activation function 326 which computes a normalized compatibility score.

In an embodiment, the present disclosure is experimented as follows: The proposed framework is implemented in TensorFlow on a GTX (Giga Texel Shader eXtreme) 1080 GPU (Graphics Processing Unit) machine. An augmentation of the data including changes in brightness, saturation and contrast in a range of [0.5, 2.0], [0.6, 1.6] and [0.7, 1.3] respectively is carried out to preclude aver-fitting. Other hyper-parameters such as learning rate, batch size, lambda weights λ_{(emb,ctr}) in the total loss function all are appropriately tuned while training the model. The present disclosure is evaluated using the simulated Pushing and simulated reaching. Further, the present disclosure is tested on a custom dataset created using our new pushing environment created in Pybullet based simulator. The performance of the present disclosure is increased by more than 60% when compared with the conventional methods.

The training set includes 1650 tasks and the test set has 15 tasks which are never given to the network during training. Input to the attentive embedding network is a 80×64 RGB images and the input to the control network is embeddings, joint angles, end effector position and the RGB Image. During testing, the task is considered a success if the end-effector comes within 0.05 meters of the goal within the last 10 timesteps. Quantitative results and comparison with state-of-the-art techniques and the present disclosure outperforms the conventional methods.

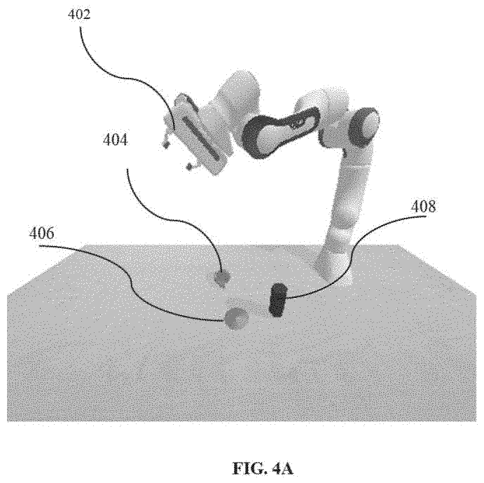

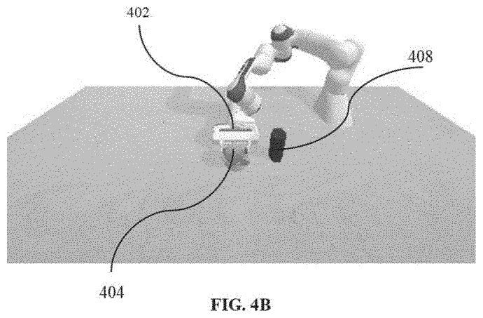

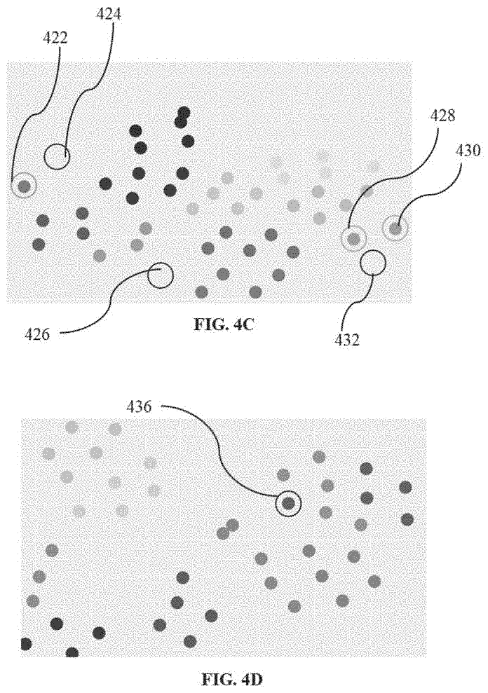

In an embodiment, the simulated pushing is explained further as follows: The aim of the simulated pushing task is to place the target object at a specific location by pushing in the presence of a distractor. The manipulator is allowed to operate in the 3D environment with an action space formed by the 7-DoF torque control vector. The observation space includes RGB images of resolution of 125×125 captured using an external camera as shown in FIG. 4A. Now referring to an example demonstration shown in FIG. 4A where the aim is to place a source object 404 at a target location 406. Here. 402 is a robotic arm and 408 is the distractor. The dataset is divided into 769 tasks for training and 74 testing. The tasks are defined as having different set of objects or context for a pushing skill, for example one task is pushing a toy chair to the target location and second task is pushing a toy elephant. Both of these tasks are having similar skill but different sets of objects. Given a demonstration from the task during training, the RGB-images are fed to the attentive-embedding network to convert them into task embeddings. These are further combined with their input-images along with joint angles (robot joint state vector) and velocities (robot joint velocity vector) from the demonstration as an input to the control network to estimate the control action like robot torque. At the time of testing, the task is considered a success if the robot pushes the target object 404 into the target location 406 for at least 10 timesteps within 100-timestep episode. The estimated attention maps are mainly concentrating on the task related pixels such as the target object, manipulator's body and end-effector and successfully able to discard the noisy information in the task embeddings. This quantitative effect shows that the method disclosed herein is able to out-perform the state-of-the art methods.

Now referring to FIG. 4B, it is observed the robotic arm is able to pick the source object 404 in the target location without picking the distractor 408. This robotic control action for picking and placing the objects is provided by the system 100.

In an embodiment, the efficiency of the attentive embedding network is evaluated by visualizing the embeddings estimated for different demonstrations of a task using t-SNE (t-distributed Stochastic Neighbor Embedding). Five demonstrations were plotted from each of the 10 randomly sampled pushing tasks in the test set and the results are depicted in FIG. 4C and FIG. 4D. Now referring to FIG. 4C, the plot illustrates the embedding clusters of the conventional method. Here, there are numerous outliers, and the outliers are marked in circles 422 through 432. FIG. 4D illustrates the embeddings clusters of the present disclosure and it is observed that there is only one outlier 436 in comparison to the clusters of the conventional methods for same set of tasks.

In an embodiment, rigorous ablation studies were performed to validate the proficiency of the proposed framework. Regarding the ablation studies, the present disclosure utilizes multiplicative skip connections coming from the attentive embedding network with the control network as shown in FIGS. 3A, 3B and 3C to better propagate the gradients from the control network to the attentive embedding network. The ablation studies were performed with other skip connection methods such as addition, concatenation or non-linear fusion with 1×1 convolutions. It is observed that the multiplicative feature fusion is working better than other methods. Further, it is observed that using spatial attention module and skip connections not only improves the embedding accuracy and success rate, but it also prevents overfitting of the network. In an embodiment, the embedding loss for the conventional method increases making embedding network overfit whereas the present disclosure does not increase the embedding loss which prevent overfitting. It is also observed that using skip connections prevent overfitting of the control network as query loss and support loss are not increasing as we train the network.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent dements with insubstantial differences from the literal language of the claims.

The embodiments of present disclosure herein address the unresolved problem of computing a control action for robotic arms using machine learning. The present disclosure utilizes spatial skip connections between the attentive embedding network and the control network which increases the accuracy of the present disclosure. Further, the attentive module of the attentive embedding network increases the performance of the present disclosure. Further, the present disclosure is performing better when tested using custom dataset including demonstrations with ambiguous background.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g, an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g, using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, the method comprising:
receiving, by one or more hardware processors, a plurality of images pertaining to a visual demonstration for a robot, wherein the plurality of images are sequential;
computing, by the one or more hardware processors, a plurality of vector embeddings based on the plurality of images using a pretrained attentive embedding network, wherein the pretrained attentive embedding network comprises a first Convolutional Neural Network (CNN), a fully connected layer and a plurality of spatial attention modules, and wherein computing the plurality of vector embeddings comprises:
computing a plurality of local contextual feature vectors based on the plurality of images by the first CNN;
computing a plurality of attention vectors based on the plurality of local contextual feature vectors and a current global feature vector using a corresponding spatial attention module among the plurality of spatial attention modules;
computing a plurality of elementwise dot products comprising an elementwise dot product between each of the plurality of attention vectors and each a corresponding plurality of local contextual feature vector;
generating a new global vector by concatenating the plurality of elementwise dot products; and
computing the plurality of vector embeddings based on the new global vector using the fully connected layer of the attentive embedding network; and
computing, by the one or more hardware processors, a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

2. The processor implemented method of claim 1, wherein each of the plurality of spatial attention modules comprises an addition unit, a convolution unit and a sigmoid activation function, wherein the new global vector is obtained from the final layer of the first CNN.

3. The processor implemented method of claim 1, wherein the pretrained attentive embedding network and the control network are tested with a custom dataset further comprising complex background.

4. The processor implemented method of claim 1, wherein the method of training the attentive embedding network comprises:
receiving a support dataset and a query dataset, wherein the support dataset comprises the plurality of sequential images corresponding a plurality of tasks, and wherein the query dataset comprises the plurality of sequential images pertaining to a specific task;
computing a first plurality of vector embeddings corresponding to each of the plurality of tasks associated with the support dataset using the attentive embedding network;
normalizing the first plurality of vector embeddings associated with the support dataset using a normalization technique;
computing a second plurality of vector embeddings corresponding to each of the plurality of tasks associated with the query dataset using the attentive embedding network;
computing the dot product similarity between the normalized first plurality of vector embeddings and the second plurality of vector embeddings; and
training the attentive embedding network based on the computed dot product similarity, wherein the training is continued until the dot product similarity between the first plurality of normalized vector embeddings and the second plurality of vector embeddings are greater than a predefined similarity threshold.

5. The processor implemented method of claim 1, wherein the method of computing the plurality of control actions based on the plurality of vector embeddings and the plurality of images using the pretrained control network comprises:
receiving the plurality of vector embeddings, the image from the plurality of images, the robot joint state vector and the robot joint velocity vector;
tiling the plurality of vector embeddings corresponding to a size associated with the image, wherein the image is randomly selected from the plurality of images;
obtaining a concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with a corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities; and
computing the control action based on the composite feature vector by using the plurality of fully connected layers of the control network.

6. The processor implemented method of claim 1, wherein the method of training the control network comprises:
receiving the plurality of vector embeddings, an image from a query dataset, the plurality of robot joint state vector and the plurality of robot joint velocity vector;
tiling the plurality of vector embeddings corresponding to a size associated with the image, wherein the image is randomly selected from the query dataset;
obtaining the concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with the corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities;
computing a first control action based on the composite feature vector by using Fully connected layers;
computing a second control action based on the composite feature vector by using Fully connected layers;
computing a total behavioral cloning loss function based on the first control action and the second control action; and
training the control network based on the total behavioral cloning loss function.

7. A system comprising:
at least one memory storing programmed instructions; one or more Input/Output (I/O) interfaces; and one or more hardware processors operatively coupled to the at least one memory, wherein the one or more hardware processors are configured by the programmed instructions to:
receive a plurality of images pertaining to a visual demonstration for a robot, wherein the plurality of images are sequential;
compute a plurality of vector embeddings based on the plurality of images using a pretrained attentive embedding network, wherein the pretrained attentive embedding network comprises a first Convolutional Neural Network (CNN), a fully connected layer and a plurality of spatial attention modules, and wherein computing the plurality of vector embeddings comprises:
computing a plurality of local contextual feature vectors based on the plurality of images by the first CNN;
computing a plurality of attention vectors based on the plurality of local contextual feature vectors and a current global feature vector using a corresponding spatial attention module among the plurality of spatial attention modules;
computing a plurality of elementwise dot products comprising an elementwise dot product between each of the plurality of attention vectors and each a corresponding plurality of local contextual feature vector;
generating a new global vector by concatenating the plurality of elementwise dot products; and
computing the plurality of vector embeddings based on the new global vector using the fully connected layer of the attentive embedding network; and
compute a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

8. The system of claim 7, wherein each of the plurality of spatial attention modules comprises an addition unit, a convolution unit and a sigmoid activation function, wherein the new global vector is obtained from the final layer of the first CNN.

9. The system of claim 7, wherein the pretrained attentive embedding network and the control network are tested with a custom dataset comprising complex background.

10. The system of claim 7, wherein the method of training the attentive embedding network comprises:
receiving a support dataset and a query dataset, wherein the support dataset comprises the plurality of sequential images corresponding a plurality of tasks, and wherein the query dataset comprises the plurality of sequential images pertaining to a specific task;
computing a first plurality of vector embeddings corresponding to each of the plurality of tasks associated with the support dataset using the attentive embedding network;
normalizing the first plurality of vector embeddings associated with the support dataset using a normalization technique;
computing a second plurality of vector embeddings corresponding to each of the plurality of tasks associated with the query dataset using the attentive embedding network;
computing the dot product similarity between the normalized first plurality of vector embeddings and the second plurality of vector embeddings; and
training the attentive embedding network based on the computed dot product similarity, wherein the training is continued until the dot product similarity between the first plurality of normalized vector embeddings and the second plurality of vector embeddings are greater than a predefined similarity threshold.

11. The system of claim 7, wherein the method of computing the plurality of control actions based on the plurality of vector embeddings and the plurality of images using the pretrained control network comprises:
receiving the plurality of vector embeddings, the image from the plurality of images, the robot joint state vector and the robot joint velocity vector;
tiling the plurality of vector embeddings corresponding to a size associated with the image, wherein the image is randomly selected from the plurality of images;
obtaining a concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with a corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities; and
computing the control action based on the composite feature vector by using the plurality of fully connected layers of the control network.

12. The system of claim 7, wherein the method of training the control network comprises:
receiving the plurality of vector embeddings, an image from a query dataset, the plurality of robot joint state vector and the plurality of robot joint velocity vector;
tiling the plurality of vector embeddings corresponding to a size associated with the image, wherein the image is randomly selected from the query dataset;
obtaining the concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with the corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities;
computing a first control action based on the composite feature vector by using Fully connected layers;
computing a second control action based on the composite feature vector by using Fully connected layers;
computing a total behavioral cloning loss function based on the first control action and the second control action; and
training the control network based on the total behavioral cloning loss function.

13. One or more non-transitory machine-readable information storage mediums comprising one or more instructions which when executed by one or more hardware processors cause:
receiving a plurality of images pertaining to a visual demonstration for a robot, wherein the plurality of images are sequential;
computing a plurality of vector embeddings based on the plurality of images using a pretrained attentive embedding network, wherein the pretrained attentive embedding network comprises a first Convolutional Neural Network (CNN), a fully connected layer and a plurality of spatial attention modules, and wherein computing the plurality of vector embeddings comprises:
computing a plurality of local contextual feature vectors based on the plurality of images by the first CNN;
computing a plurality of attention vectors based on the plurality of local contextual feature vectors and a current global feature vector using a corresponding spatial attention module among the plurality of spatial attention modules;
computing a plurality of elementwise dot products comprising an elementwise dot product between each of the plurality of attention vectors and each a corresponding plurality of local contextual feature vector;
generating a new global vector by concatenating the plurality of elementwise dot products; and
computing the plurality of vector embeddings based on the new global vector using the fully connected layer of the attentive embedding network; and
computing a control action based on the plurality of vector embeddings, an image from the plurality of images, a robot joint state vector and a robot joint velocity vector using a control network, wherein the control network comprises a second CNN and a plurality of fully connected layers, and wherein the control network is connected to the attentive embedding using multiplicative spatial skip connections.

14. The one or more non-transitory machine-readable information storage mediums of claim 13, wherein each of the plurality of spatial attention modules comprises an addition unit, a convolution unit and a sigmoid activation function, wherein the new global vector is obtained from the final layer of the first CNN.

15. The one or more non-transitory machine-readable information storage mediums of claim 13, wherein the pretrained attentive embedding network and the control network are tested with a custom dataset comprising complex background.

16. The one or more non-transitory machine-readable information storage mediums of claim 13, wherein the method of training the attentive embedding network comprises:
receiving a support dataset and a query dataset, wherein the support dataset comprises the plurality of sequential images corresponding a plurality of tasks, and wherein the query dataset comprises the plurality of sequential images pertaining to a specific task;
computing a first plurality of vector embeddings corresponding to each of the plurality of tasks associated with the support dataset using the attentive embedding network;
normalizing the first plurality of vector embeddings associated with the support dataset using a normalization technique;
computing a second plurality of vector embeddings corresponding to each of the plurality of tasks associated with the query dataset using the attentive embedding network;
computing the dot product similarity between the normalized first plurality of vector embeddings and the second plurality of vector embeddings; and
training the attentive embedding network based on the computed dot product similarity, wherein the training is continued until the dot product similarity between the first plurality of normalized vector embeddings and the second plurality of vector embeddings are greater than a predefined similarity threshold.

17. The one or more non-transitory machine-readable information storage mediums of claim 13, wherein the method of computing the plurality of control actions based on the plurality of vector embeddings and the plurality of images using the pretrained control network comprises:
receiving the plurality of vector embeddings, the image from the plurality of images, the robot joint state vector and the robot joint velocity vector;
tiling the plurality of vector embeddings corresponding to a size associated with the image, wherein the image is randomly selected from the plurality of images;
obtaining a concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with a corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities; and
computing the control action based on the composite feature vector by using the plurality of fully connected layers of the control network.

18. The one or more non-transitory machine-readable information storage mediums of claim 13, wherein the method of training the control network comprises:
receiving the plurality of vector embeddings, an image from a query dataset, the plurality of robot joint state vector and the plurality of robot joint velocity vector;
tiling the plurality of vector embeddings corresponding to a size associated with the image, wherein the image is randomly selected from the query dataset;
obtaining the concatenated data by concatenating the plurality of tiled vector embeddings and the image;
computing a plurality of element-wise feature maps based on the concatenated data using the second CNN;
computing a plurality of fusion feature maps by multiplying each of the plurality of element-wise feature maps with the corresponding feature maps of the attentive embedding network;
computing a flattened feature map based on the plurality of fusion feature maps using the second CNN;
generating a composite feature vector by concatenating the flattened feature map, the plurality of robot joint states and the plurality of robot joint velocities;
computing a first control action based on the composite feature vector by using Fully connected layers;
computing a second control action based on the composite feature vector by using Fully connected layers;
computing a total behavioral cloning loss function based on the first control action and the second control action; and
training the control network based on the total behavioral cloning loss function.
